(19) United States
(12) Patent Application Publication
(10) Pub. No.: US 2024/0276604 A1
(43) Pub. Date: Aug. 15, 2024

(54) Electric Heating Device and Method for its Production

(71) Applicant: Eberspächer catem GmbH & Co.KG, Herxheim (DE)

(72) Inventors: Patrick Werner, Neuhofen (DE); Timo Kröner, Rülzheim (DE)

(21) Appl. No.: 18/436,631

(22) Filed: Feb. 8, 2024

(30) Foreign Application Priority Data
Feb. 10, 2023 (DE) 10 2023 103 296.8

(51) Int. Cl. H05B 3/06; H05B 3/00

(52) U.S. Cl. CPC H05B 3/06; H05B 3/0019; H05B 2203/016

(57) ABSTRACT

An electric heating device includes a casing with a partition wall which separates a connection chamber from a heating chamber for dissipating heat to a medium to be heated. At least one heating rib projects from the partition wall in the direction toward the heating chamber and supports, in an insulated manner, at least one PTC element and conductor tracks for energizing the PTC element with different polarities. A control device with a populated control circuit board is provided in the casing. At least one connector casing is provided in the casing and has electrically conductive plugging elements that are electrically connected to the control circuit board. An electric heating device, which is used exclusively for the electrical connection of the plugging elements, is electrically connected to the control circuit board by way of at least one electrical connector.

### BACKGROUND OF THE INVENTION

### 1. Field of the Invention

The present invention relates to an electric heating device comprising a casing with a partition wall which separates a connection chamber from a heating chamber for dissipating heat to a medium to be heated and from which at least one heating rib projects in the direction towards the heating chamber. The heating rib supports at least one PTC element and conductor tracks electrically connected in the connection chamber for energizing the PTC element with different polarities and connected to the latter in an electrically conductive manner. A control device with a populated control circuit board is provided in the casing of the electric heating device. The control device can be arranged in the connection chamber or a in a control casing. At least one connector casing is provided at the casing, the electrically conductive plugging element of which is electrically connected to the control circuit board.

### 2. Background of Related Art

Such an electric heating device is known, for example, from DE 20 2019 005 223 U1 or from EP 3 334 243 A1 and its United States counterpart U.S. Pat. No. 10,429,099, the subject matter of which is incorporated herein in its entirety.

The present invention is based on the problem of providing an electric heating device of the kind mentioned at the outset which can be more easily adapted to the customer's individual specifications.

Electric heating devices according to the invention are typically provided in a motor vehicle. The heating devices have in common the task of heating the medium to be heated, typically a liquid medium, in the vehicle. In particular in the field of electromobility, the medium electrically heated in this manner is used to bring units within the electrically operated vehicle to a specific operating temperature and/or to air-condition the interior within the vehicle. This is typically done by passing the heated liquid medium over a heat exchanger through which air to be heated flows.

The electric heating device of the present kind typically has several heating ribs which can accommodate one or more PTC elements. Several PTC elements can be energized by way of two conductor tracks. Several conductor tracks can also be provided in a heating rib for energizing various PTC elements. The PTC elements can be provided one above the other in the height direction of the heating rib or transverse thereto adjacent to one another. The height direction is the direction in which the heating rib projects from the partition wall. The heating rib is typically open to the connection chamber in the height direction.

The heating rib can be formed by a heating device casing which is typically made of metal and is connected to the partition wall monolithically or by joining. The partition wall can be part of a casing upper part, which may be formed to be metallic for shielding the switches of the populated circuit board provided in the connection chamber. It is also possible to provide the partition wall solely with receptacles and to insert the heating ribs into these receptacles, as is described in EP 3 334 243 A1 and U.S. Pat. No. 10,429,099.

The heating ribs can each be individually fitted or provided with the required number of PTC elements or PTC elements of different sizes in order to adapt the heating output of the electric heating device. This allows the maximum heat emitted by the heating device to be individually adapted to customer requirements. Such an adaptation does not require any fundamental change to the electric heating device with regard to the electrical connection of the individual heating ribs or the PTC elements provided thereby or therein, respectively. It is known in prior art to connect the various heating ribs by way of a connection module. This connection module typically has no electrical or electronic components. It is used solely to group PTC elements from different heating ribs to form specific heating circuits. The connection module can have various sheet metal segments that are electrically separated by punching and are received and positioned in a plastic frame. The PTC elements can be grouped in various heating circuits using these busbars; compare DE 20 2019 005 223 U1.

The populated control circuit board previously mentioned is electrically connected to this non-populated circuit board. It has, for example, at least one power switch that is associated with a specific heating circuit and controls its power output. The control circuit board can comprise further electrical or electronic components.

As is known from EP 3 334 243 A1(and its US counterpart U.S. Pat. No. 10,429,099) or DE 20 2019 005 223 U1, respectively, this control circuit board is electrically connected to plugging elements of a connector casing which is exposed on the outer side of the casing of the electric heating device for electrically contacting the electric heating device to the power current or to control signals. This at least one connector casing typically follows the customer's specifications in terms of its design and arrangement. In previously mentioned prior art, the control circuit board comprises connector mating elements for the electrical connection of the connector elements to the at least one connector casing.

### SUMMARY

The present invention proposes a connection circuit board which is used exclusively for the electrical connection of the plugging elements and which is electrically connected to the control circuit board by way of at least one electrical connector. The connection circuit board may comprise connector mating elements for the direct electrically conductive plugging contact of the plugging elements of the connector.

In the solution according to the invention, the electrical connection to the power current and/or to incoming control signals takes place exclusively via the connection circuit board, possibly through connector mating elements provided at the connection circuit board for contacting the plugging elements. The electrical connection is then established on a different circuit board than the one on which the electrical or electronic components are provided. The connection circuit board typically has no electrical or electronic components. It is used only for contacting, typically plug contacting, the connectors for the power current and/or for the control signals. The control circuit board, on the other hand, has no electrical connection elements that are directly electrically connected to a plugging element of a connector casing. The electrical connection to the plugging elements is instead effected via the connection circuit board.

It is therefore possible to keep the control circuit board unchanged as part of an electric heating device that has already been designed, provided it basically meets the requirements of another customer, but the customer demands specific specifications with regard to the type and/or arrangement of the connecter for the power current or the control signals. In this case, only the connection circuit board needs to be adapted to the customer's individual specifications. The control circuit board does not need to be configured separately and can be adopted in an unchanged manner.

According to a development, it is proposed to provide the control circuit board and the connection circuit board at substantially the same height. The control circuit board and the connection circuit board can extend substantially parallel to the partition wall. The two electrically connected circuit boards can extend transverse to the height direction of the heating rib and can be provided directly above the contact-side ends of the conductor tracks that are exposed in the connection chamber. These contact-side ends of the conductor tracks are typically formed by contact spades which are formed by cutting free the ends of sheet metal which form the conductor tracks and which abut in an electrically conductive manner directly against the PTC element or elements. They are typically made of ceramic and have a metallization on their main side surfaces. The contact plates typically abut against this metallization in an electrically conductive manner. According to the present invention, the position of the plugging elements is not necessarily confined to only that region which adjoins the heating chamber directly in the height direction of the heating rib and is separated therefrom by the partition wall. Instead, the connection module for connecting the heating ribs can extend substantially parallel to the partition wall, whereas the connection circuit board and the control circuit board can be provided in a separate control housing and be electrically connected to the non-populated circuit board, as is disclosed in EP 3 334 243 A1 and U.S. Pat. No. 10,429,099.

For a compact configuration, the connection circuit board and the populated circuit board may be disposed in the connection chamber. These two circuit boards preferably extend parallel to the non-populated circuit board; compare DE 20 2019 005 223 U1.

The connector casing may comprise male contact spades and the connection circuit board comprises female contact spade receptacles for receiving these male contact spades in a plugging contact manner. The contact spade received in the contact spade receptacle may pass through the connection circuit board. In other words, the contact spades protrude through the connection circuit board. In order to increase the electrical strength, in particular when operating the electric heating device with a high voltage and thereby, for example, with the power current of an electric vehicle of at least 48 volts, it is proposed according to an embodiment of the present invention to provide on the casing a power connector casing for transmitting the power current and a control connector casing for transmitting the control current. An insulating web formed by the power connector casing is provided between the plugging elements of the power connector casing and is inserted into an insulating web receptacle recessed in the connection circuit board. This insulating web increases the clearance and creepage distance between the various contact spades of the connector casing, which are assigned different polarities. The insulating web there typically projects beyond the contact spades in their direction of extension and thereby the direction of insertion. The insulating web is typically wider than the free ends of the contact spades. These measures lead to increased electrical safety. The insulating web receptacle is dimensionally closely adapted to the size of the insulating web.

The electrical connection between the connection circuit board and the populated circuit board can be established using any board-to-board connector. However, electrical connectors with increased electrical carrying capacity are typically used, in particular for conducting the power current. For this purpose, the populated control circuit board and the connection circuit board have mutually associated female plugging element receptacles which are received at least in part in the control circuit board or the connection circuit board, respectively. The mutually associated plugging element receptacles are electrically connected to one another by busbars. The busbars may be formed to be U-shaped and have oppositely disposed plugging spades. The plugging element receptacles may be shaped like the punched connecting members described in EP 2 236 330 A1 and its U.S. counterpart U.S. Pat. No. 8,803,036, the subject matter of which is incorporated herein by reference. Such plugging element receptacles are typically disposed opposite each other on adjacent edges of the populated control circuit board on the one side and the connection circuit board on the other side. The U-shaped busbars bridge the edges of the two printed circuit boards and are electrically contacted at the plugging element receptacles between spring spades of the plugging element receptacles provided within the printed circuit boards. These spring spades can also be gathered from EP 2 236 330 A1 and U.S. Pat. No. 8,803,036.

### BRIEF DESCRIPTION OF THE DRAWINGS

Further details and advantages of the present invention shall become apparent from the following description of an embodiment in combination with the drawing, where:

FIG. 1 shows a perspective lateral view of an embodiment of an electric heating device with the heating chamber facing upwards;

FIG. 2 shows a perspective view of the embodiment according to FIG. 1 with the heating chamber facing downwards;

FIG. 3 shows a cross-sectional view of the casing upper part of the embodiment according to FIGS. 1 and 2;

FIG. 4 shows a perspective top view of the embodiment on the side of the connection chamber and

FIG. 5 shows a perspective bottom view of the control device in FIG. 4.

### DETAILED DESCRIPTION

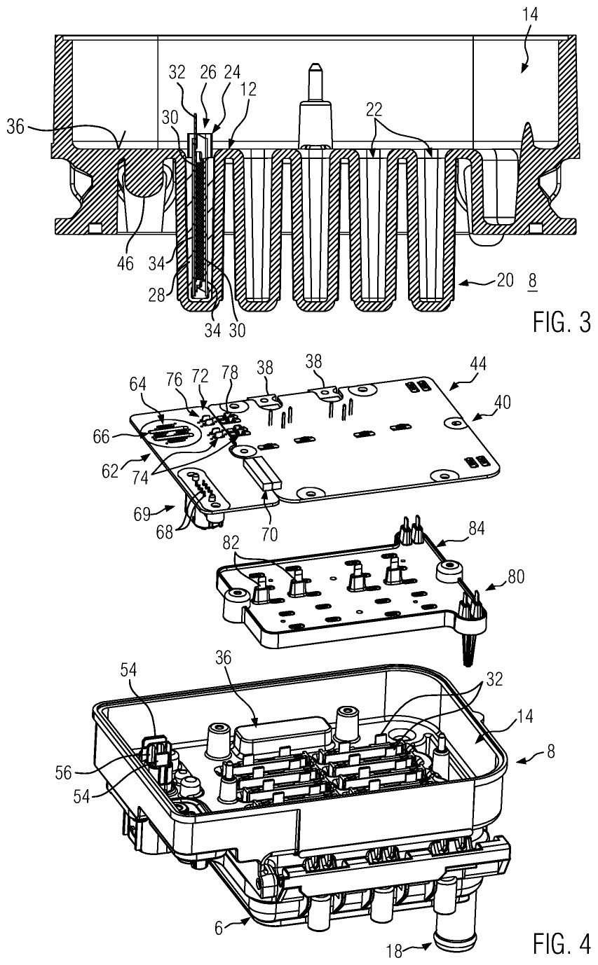

FIGS. 1 to 3 show a heating device with a casing denoted overall by reference character 2. The casing 2 has a casing upper part 4 made of metal, a casing lower part 6 made of plastic material which is connected to the casing upper part 4 in a fluid-tight manner to form a heating chamber 8, and a casing cover 10 which is connected to the casing upper part 4 in a fluid-tight manner. The heating chamber is denoted by reference character 8 in FIG. 3, although the casing lower part 6 is not shown there. The casing upper part 4 forms a connection chamber 14 between the casing cover 10 and a partition wall denoted by reference character 12. The partition wall 12 separates the connection chamber 14 from the heating chamber 8.

The casing lower part 6 forms an inlet port 16 integrally formed thereon and an outlet port 18 integrally formed thereon. Hoses for guiding the liquid medium to be heated can be connected to these ports 16, 18.

The ports 16, 18 lead into the heating chamber 8. Heating ribs 20 project into this heating chamber 8. Each heating rib 20 is formed by the outer surfaces of a receiving pocket denoted by reference character 22 in FIG. 4 which is closed towards the heating chamber 8 and open towards the connection chamber 14.

In the present case, two PTC heating devices 24 are provided in each receiving pocket 22. Each PTC heating device 24 has a frame 26 which accommodates a PTC element 28 and combines two conductor tracks in the form of contact plates 30 to form a unit which abut directly in an electrically conductive manner against the main side surfaces of the PTC element 28 and form contact spades 32 protruding into the connection chamber 14. The contact plates 30 are provided on the outer side with an insulating layer 34, for example, an aluminum oxide plate or an electrically insulating film, respectively. As a result, the contact plates 30 are supported in an insulating manner in the receiving pocket 22. Good heat-conducting contact between the main side surfaces of the PTC element 28 can be obtained, for example, by wedging the PTC element 28 together with the contact plates and the insulating layers 34 into the receiving pocket 22; compare DE 10 2019 216 481 A1.

In FIG. 4, a cooling surface 36, which is formed by the partition wall 12 and against which power switches 38 are abutted in a heat-conducting manner, can be seen laterally next to the receiving pockets 22. These power switches 38 are mounted on a populated control circuit board 40 and abutted against the cooling surface 36 formed by the casing upper part 4 with the interposition of a well heat-conducting insulating film. This populated control circuit board 40 forms the essential part of a control device 44. Below the cooling surface 36, a cooling rib 46 formed by the metallic casing lower part 6 projects into the heating chamber 8.

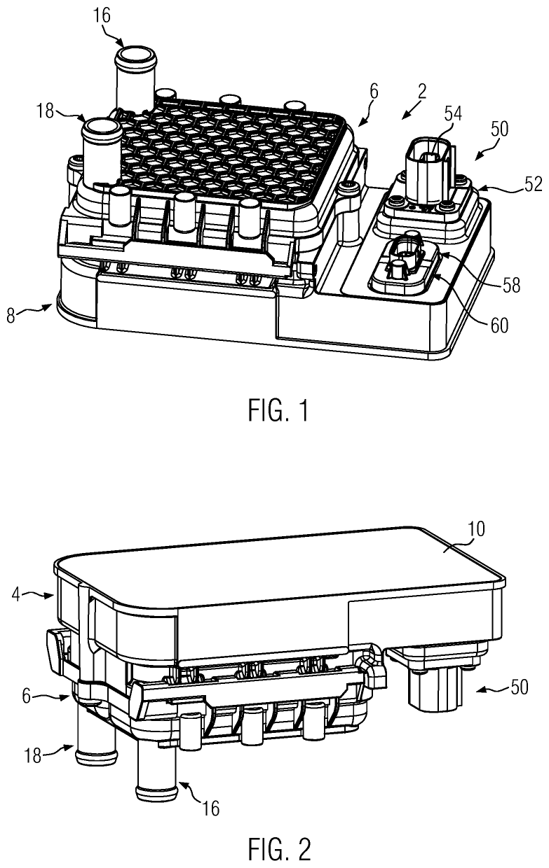

FIGS. 1 and 2 show a power connector 50 with a power connector casing 52. This power connector 50 has two power plugging elements 54 which are exposed in the connection chamber 14 (cf. FIG. 4) and which form male contact spades. In this FIG. 4, reference character 56 denotes an insulating web 56 formed by the power connector casing 52 and extending between the two power plugging elements 54.

A control connector with a control connector casing 60 with reference character 58 can be seen in FIG. 1. This control connector 58 as well has control connector plugging elements that are not shown in detail.

Reference numeral 62 denotes a connection circuit board in FIG. 4 which evidently forms connector mating elements 64 in the form of female contact spade receptacles for the power plugging elements 54. An insulating web receptacle 66 for receiving the insulating web 56 is provided between these connector mating elements 64.

Connector mating elements for the control connector plugging elements of the control connector 58 are formed by contact pins 68 which are received in an insulating pin strip 69 which is firmly connected to the connection circuit board 62. The control connector plugging elements of the control connector 58 are thereafter indirectly electrically connected in a plugging contact manner to the connection circuit board 62 via the contact pins 68 which are firmly connected to the connection circuit board 62 and electrically contacted therein.

The connection circuit board 62 is electrically connected by a board-to-board connector 70 to the populated control circuit board 40. The control signals are transmitted through the former from the connection circuit board 62 to the populated circuit board 40.

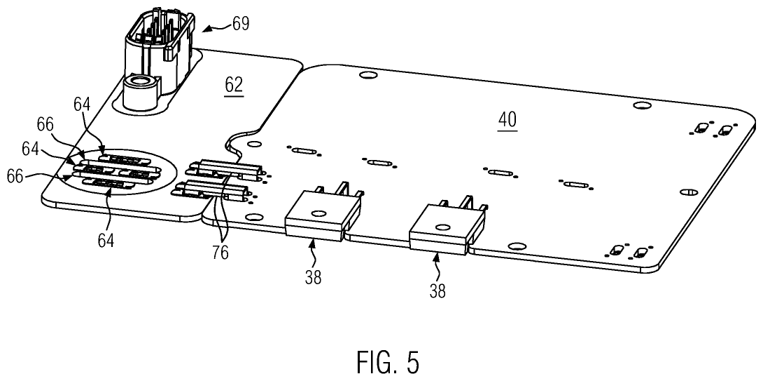

Reference numeral 72 denotes another electrical connector which is used to transmit the power current between the control circuit board 40 and the connection circuit board 62. For this purpose, female plugging element receptacles 74, as they are known from EP 2 236 330 A1, are respectively introduced on the side of the control circuit board 40 and of the connection circuit board 62. Two such plugging element receptacles 74 are provided for each polarity. The plugging element receptacles 74 provided in pairs are each connected to a busbar 76 formed to be U-shaped, the plugging spades 78 of which are inserted into the plugging element receptacles 74 and are there connected in an electrically conductively manner to the plugging element receptacles 74. FIG. 5 shows a base of these busbars 76 which respectively bridge the two circuit boards 40; 62. Each busbar 76 is cut from a sheet of metal so that two respective plugging spades 78 projecting from a rectangular base area of the sheet metal are disposed opposite one another. The sheet metal is then bent to be U-shaped, which gives the busbar 76 increased rigidity. The bending is carried out in such a way that, after bending, the plugging spades 78 provided at one end are disposed opposite one another. The plugging spades 78 are connected in a plugging contact manner in pairs respectively in the populated circuit board 40 and the connection circuit board 62 in corresponding plugging element receptacles 74.

Reference numeral 80 denotes a connection module that is provided for the electrical connection of the contact spades 32 and groups the individual heating ribs 20 to form heating circuits. The connection module 80 is provided between the heating ribs 20 and the control circuit board 40, but not below the connection circuit board 62. Extending between the non-populated circuit board 80 and the control circuit board 40 are connector spades 82 which are associated with the individual heating circuits of the non-populated circuit board 80 and are surrounded by a plastic material which forms a plastic frame 84 of the non-populated circuit board 80 which combines various busbars of the non-populated circuit board 80 to form a unit.

1. An electric heating device comprising:
a casing having a partition wall which separates a connection chamber from a heating chamber for dissipating heat to a medium to be heated;
least one a heating rib which projects from the partition wall in a direction toward said heating chamber, wherein the heating rib supports, in an insulated manner, at least one PTC element and conductor tracks that are connected to the PTC element in said connection chamber, the conductor tracks being connected to the PTC element in an electrically conductive manner for energizing said PTC element with different polarities;
a control device that is provided in said casing, said control device having a populated control circuit board;
at least one connector casing that is provided in said casing, wherein said connector casing has electrically conductive plugging elements which are electrically connected to said control circuit board; and
a connection circuit board which is electrically connected to said control circuit board by way of at least one electrical connector, wherein said connection circuit board is used exclusively for the electrical connection of the plugging elements.

2. The electric heating device according to claim 1, wherein said control circuit board comprises connector mating elements that contact said connector elements in an electrically conductive manner.

3. The electric heating device according to claim 1, wherein said control circuit board and said connection circuit board are accommodated in said connection chamber at substantially a common height.

4. The electric heating device according to one of the claims 1 , wherein said connector casing comprises male plugging contact spades, wherein said connection circuit board comprises female contact spade receptacles, which receive said plugging contact spades, and wherein said plugging contact spade, when received in said contact spade receptacles, pass through said connection circuit board.

5. The electric heating device according to claim 4, wherein a power connector casing for transmitting power current and a control connector casing for transmitting control current are provided on said casing, and wherein an insulating web, formed by said power connector casing, is provided between the plugging elements of said power connector casing and is inserted into an insulating web receptacle that is recessed in said connection circuit board.

6. The electric heating device according to claim 1, wherein said control circuit board and said connection circuit board comprise mutually associated female plugging element receptacles which are received, at least in part, in said control circuit board or said connection circuit board, respectively, and wherein said mutually associated plugging element receptacles are electrically connected to one another by busbars.

7. The electric heating device according to claim 1, wherein a connection module is provided between said control circuit board and said heating rib and comprises a plugging element receptacle for making plugging contact of said conductor tracks to several heating ribs and additionally comprises female contact spades for making plugging contact in said control circuit board.
